(19) United States
(12) Patent Application Publication
(10) Pub. No.: US 2012/0328392 A1
(43) Pub. Date: Dec. 27, 2012

(54) Toggle bolt fastener and method of operation

(76) Inventor: Agostino Difante, San Clemente, CA (US)

(21) Appl. No.: 13/134,903

(22) Filed: Jun. 21, 2011

(51) Int. Cl. F16B 13/10; F16B 13/04

(52) U.S. Cl. 411/342

(57) ABSTRACT

The present invention relates to a toggle-bolt fastener for mounting various objects on a hollow mounting surface, the toggle bolt fastener having a single toggle piece, or clamping member, attached to one end of a spring, the other end of the spring attached to a hollow securing nut, the spring allowing the clamping member to be folded back and inserted into the securing nut for insertion of the fastener through the mounting surface.

### BACKGROUND

The background of the invention will be discussed in two parts.

1. Field of the Invention

The present invention relates in general to toggle-bolt fastener for mounting various objects on a hollow mounting surface, and more particularly to a toggle bolt fastener having a single toggle piece, or clamp, attached to one end of a resilient member, such as a spring, the other end of the resilient member attached to a hollow securing member, the resilient member allowing the toggle clamp to be folded back and inserted into the securing member for insertion of the fastener through the mounting surface.

2. Prior Art

Fasteners for mounting various objects or articles upon hollow mounting surfaces are known, however, prior art fasteners are too complex, are inefficient, or are uneconomical. Typical such fasteners are disclosed within U.S. Pat. No. 5,067,864 which issued Nov. 26, 1991 to Dewey et al., U.S. Pat. No. 4,601,625 issued on Jul. 22, 1986 to Ernst et al., and U.S. Pat. No. 4,449,873 issued on May 22, 1984 to Barth. While the fasteners disclosed within these patents have been generally satisfactory, they exhibit operational deficiencies. In view of these deficiencies in the prior art it is a feature of the present invention to provide a new and improved toggle bolt fastener for mounting within hollow wall structures, such as drywall structures, in order to mount various articles upon the structures. It is another feature of the invention is to provide a new and improved toggle bolt fastener, for mounting in hollow wall structures, which effectively overcomes the various structural and operational deficiencies, disadvantages, and drawbacks characteristic of conventional toggle bolt fasteners. A further feature of the invention is to provide a new and improved toggle bolt fastener which comprises integrally incorporated structure for ensuring the proper engagement of a toggle clamp with the rear or inner surface portion of hollow wall structures.

### SUMMARY

The foregoing and other features are accomplished by providing a new and improved toggle bolt fastener assembly for mounting various objects or articles upon a mounting surface such as drywall or any other hollow wall assembly. The assembly of the invention has a single toggle clamping member, attached proximate its center point to one end of a helical-shaped spring, the other end of the spring attached to the back side of a disc-shaped hollow securing member. The clamping member is allowed by the spring to bend back 90 degrees in-line with the securing member with the spring placed within the trough of one end of the clamping member, the combination inserted into the back portion of the hollow securing member. This assembly is inserted into a hole in the mounting surface after which a bolt is inserted through the front of the securing member, through the spring and against the bent portion of the spring to stretch the spring and force the clamping member from the securing member. After clearing the securing member, under spring tension the clamping member then opens up behind the mounting surface. The invention will become more readily apparent from a reading of the specification when taken in conjunction with the drawings in which like reference numerals refer to like elements in the several views.

### DRAWINGS

FIG. 1 illustrates the component parts of a toggle bolt fastener in accordance with the invention;

FIG. 2 shows the clamping member of FIG. 1 folded 90 degrees back against the spring tension with one end of the clamping member inserted into the inward side of the securing member;

FIG. 3 illustrates the bolt being inserted into the outward side of the securing member and toward the inserted clamping member;

FIG. 4 shows the bolt having made contact with the spring and plastic sleeve of the clamping member to push the clamping member from the securing member allowing for the clamping member to resiliently spring back to its original orientation and open up within the cavity of a hollow wall;

FIG. 5 illustrates the bolt, and in cross-section the assembled securing member, spring, and clamping member of the invention;

FIG. 6 illustrates the clamping member ready for insertion into the hole in the mounting surface, the clamping member folded back from the toggle nut and captured by the securing member;

FIG. 7 indicates the clamping member inserted into the wall or other mounting surface with the bolt ready to be inserted into the spring and flexible plastic sleeve;

FIG. 8 illustrates the clamping member in place through the mounting surface and indicates pushing of the bolt against the spring and plastic sleeve to force the clamping member far enough to spring open behind the mounting surface;

FIG. 9 illustrates the clamping member open behind the mounting surface with the bolt ready to be removed to allow the clamping member to spring back flush against the back of the mounting surface.

FIG. 10 shows the clamping member set in place in the mounting surface and ready to accept the bolt; and

FIG. 11 shows the bolt inserted through the object to be secured and screwed into the end nut to tighten the clamping member enough to secure the object to the mounting surface.

### DESCRIPTION

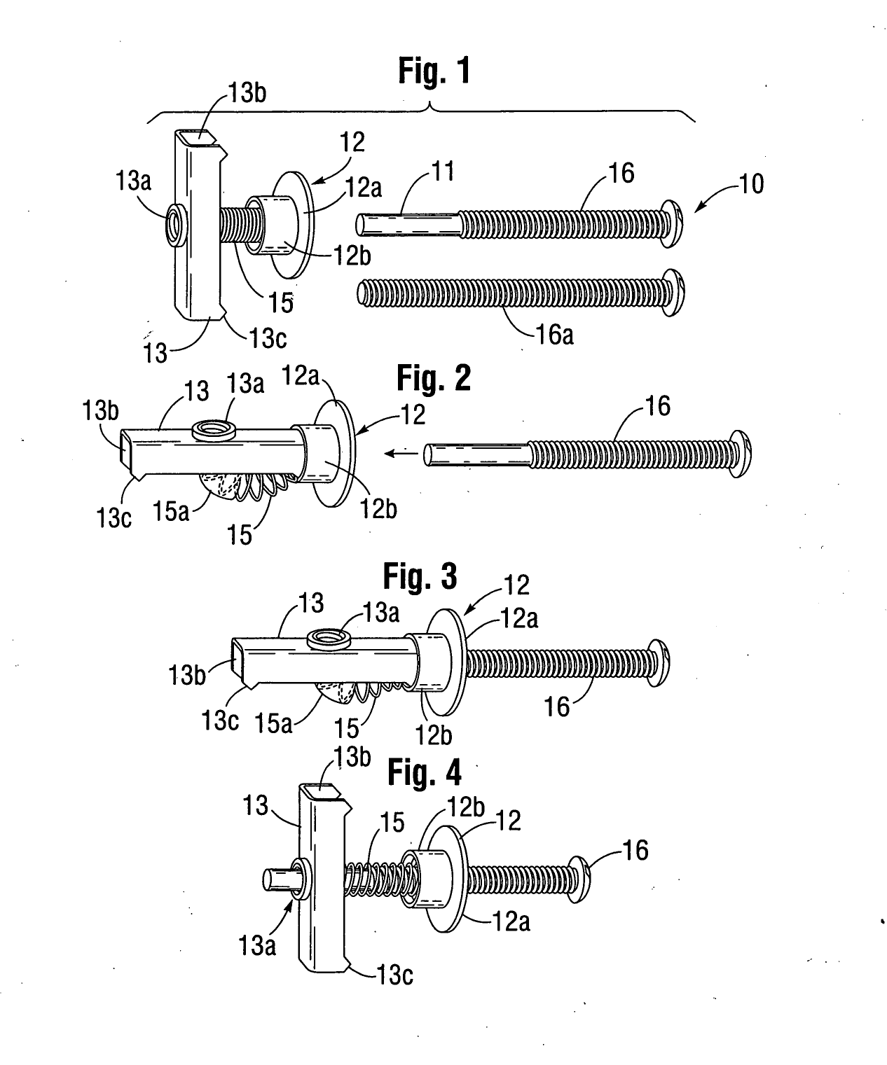

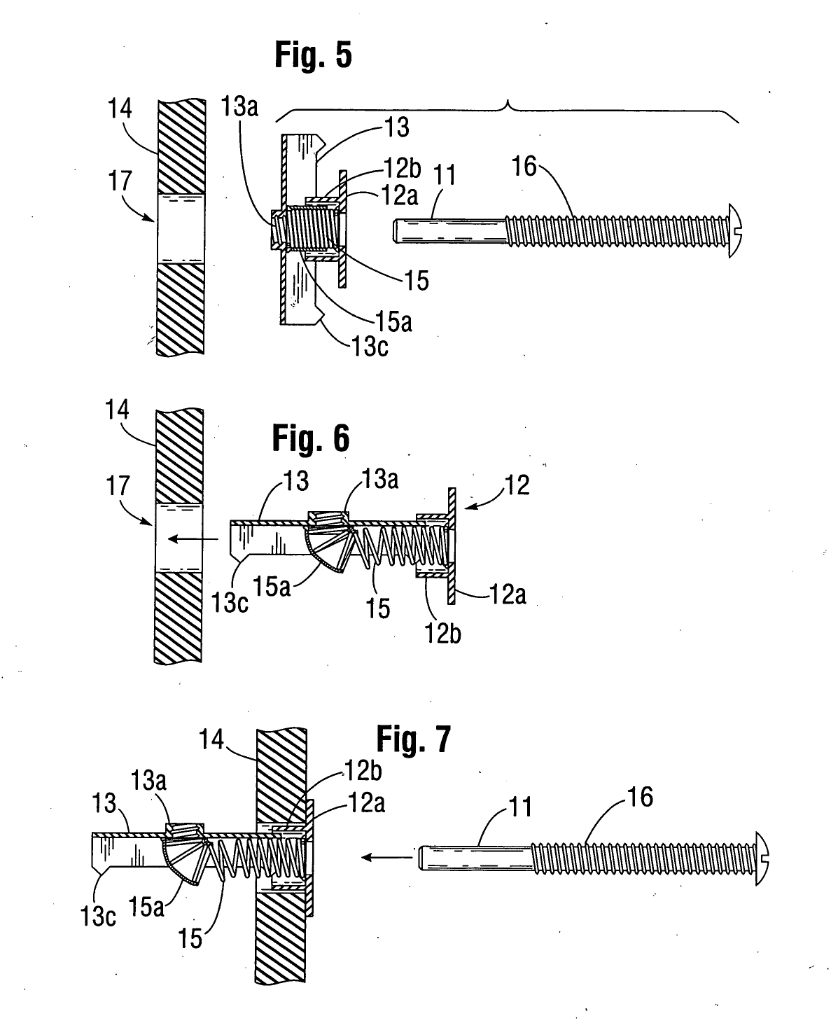

Referring now to the drawings and initially to FIG. 1, there is disclosed a new and improved toggle bolt fastener in accordance with the principles and teachings of the present invention, and generally indicated by the reference numeral 10. The toggle bolt fastener 10 is uniquely adapted for mounting various objects upon a suitable mounting surface 14 (FIG. 5). As shown, the toggle bolt fastener 10 comprises a hollow securing member generally designated 12, a clamping member 13 having a trough 13b and an end nut 13a, grasping pins or teeth 13c, a resilient member such as a spring 15 connected at one end to securing member 12 and the other end to clamping member 13, and a bolt 16. Bolt 16 may be completely threaded (16a) or have a smooth milled surface 11 at the front end of the bolt 16. Securing member 12 is shown having a generally disc-shaped front portion 12a and a tubular protruding rear portion 12b. Portions 12a and 12b have the same inside diameter with rear portion 12b having a smaller outside diameter than portion 12a. Rear portion 12b has an outside diameter suitable for insertion into a drilled hole 17 in the mounting surface 14 whereas disc-shaped front portion 12a has a diameter large enough to cover the drilled hole 17 and preclude passage therethrough of the assembly 10. In this manner, when the securing member 12 is inserted into the drilled hole 17 and mounted within the mounting surface 14, the toggle bolt fastener 10 will be engaged within the mounting surface 14 so as to properly seat and retain the fastener 10. The portion 12a of the toggle fastener 10 will now be positioned flush against the front or outer side of the mounting surface 14. As shown, bolt 16, securing member 12, spring 15, and clamping member 13 are aligned to a common axis.

FIG. 2 illustrates the clamping member 13 folded back against the tension of helical spring 15, placed within trough 13b of one end of clamping member 13, and the combination inserted into the inward opening of portion 12b of the securing member 12, rear portion 12b and spring 15 being aligned to a common axis. Spring 15 has an associated flexible sleeve 15a at the junction of spring 15 and clamping member 13.

FIG. 3 shows the insertion of threaded bolt 16 into the outward side of the securing member 12 wherein bolt 16 is inserted through the spring 15 and trough 13b toward the bent portion of the spring 15 and the associated sleeve 15a.

FIG. 4 illustrates the bolt 16 having made contact with the spring 15 and plastic sleeve 15a at its junction point with threaded toggle end nut 13a and to thereby push clamping member 13 from the securing member 12 allowing for the toggle clamping member 13 to spring back to its original perpendicular orientation. Bolt 16 is shown partially inserted into end nut 13a in preparation for threaded engagement with threaded nut 13a for tightening clamp member 13 against the inside of the mounting surface 14. If bolt 16a is used it will not yet be screwed into nut 13a.

FIG. 5 illustrates the bolt 16, and in cross-section the assembled securing member 12, spring 15 and toggle clamping member 13. It is seen that spring 15 is in a relaxed state and thus holding clamping member 13 in close proximity to securing member 12.

FIG. 6 illustrates the toggle fastener 10 of the invention with the clamping member 13 folded back 90 degrees against the tension of spring 15 with one end inserted into portion 12b of the securing member 12. The folded configuration is now assembled and positioned for insertion into the drilled hole 17.

FIG. 7 indicates the assembled securing member 12, spring 15 and toggle piece 13 inserted through the hole 17 in mounting surface 14 with the bolt 16 indicated ready to be inserted into the spring 15 and associated sleeve 15a.

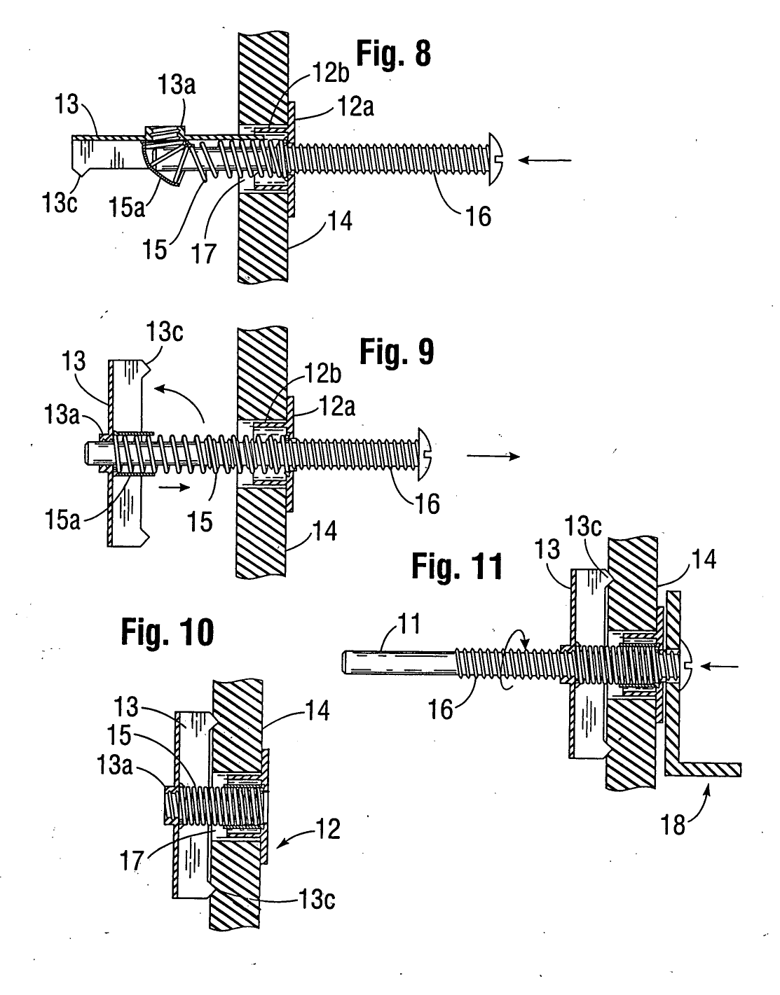

FIG. 8 illustrates the assembled securing member 12, spring 15 and toggle clamping member 13 in place through mounting surface 14 and shows initial insertion of the threaded bolt 16 against the bent portion of the spring 15 and sleeve 15a to force the clamping member 13 far enough through the mounting surface hole 17 to allow clamping member 13 to spring open behind the mounting surface 14 and spring back against the inside of the mounting surface 14.

FIG. 9 illustrates the clamping member 13 open behind the mounting surface 14 and in position to spring back against the back of mounting surface 14, either along the smooth milled surface 11 of bolt 16 or when the bolt 16 is removed.

FIG. 10 shows the toggle bolt fastener of the invention assembled and properly seated in place within hole 17 of the mounting surface 14 with the bolt 16 removed. It is seen that the grasping teeth 13c of clamping member 13 are shown embedded in the inside of the mounting surface 14 to resist and fix engagement of the clamping member 13 and the inside of the mounting surface 14. Grasping teeth 13c may be of any suitable configuration.

FIG. 11 shows toggle bolt 16 attached to object 18, screwed into end nut 13a, and tightened to secure clamping member 13 against the inside of mounting surface 14 and thus secure the object 18 in place. Portion 12b of securing member 12 is firmly seated within mounting surface hole 17 as to prevent vertical or horizontal movement of the bolt 16. In this manner the load of object 18 is borne by the bolt 16 and clamping member 13; the spring 15 not bearing any of the load. An embodiment of the invention has above been described and illustrated, however, it is to be understood that the spring 15, securing member 12, clamping member 13, and other components may in keeping with the invention be other than as described and illustrated.

In review, the assembly of the invention has a unitary longitudinal clamping member attached proximate its center to one end of a helical spring, the other end of the spring attached to a hollow securing member. The clamping member is allowed by the spring to be bent back 90 degrees in-line with the securing member with the spring placed within a trough in the clamping member, after which the clamping member and spring is inserted into the back portion of the hollow securing member. This combination is inserted through a hole in the mounting surface until stopped by the larger diameter front portion of the securing member after which a threaded bolt is pushed through the securing member from the front to force the clamping member to emerge from the hole and spring back to a perpendicular position relative to the bolt and then spring back against the interior of the mounting surface. The bolt is then removed from the installed assembly, appropriately attached to the object to be secured to the mounting surface, inserted through the assembly, and threaded into the nut of the clamping member thereby tightening the clamping member against the inside of the mounting surface and securing the desired object.

While an embodiment of the invention has been described and illustrated herein, it will be understood by one skilled in the art that modifications and adaptations of the present invention may be made in light of the above teachings without departing from the spirit and scope of the invention described, illustrated, and claimed herein.

What is claimed is:

1. A toggle bolt fastener assembly for mounting articles onto a hollow mounting member, said assembly comprising:
a hollow securing member configured for fitting within a hole in a mounting member;
a longitudinal toggle clamping member;
a longitudinal helical spring having a first end attached to said toggle clamping member approximate the center thereof and a second end attached to said securing member;
said spring and a selected end of said clamping member is folded back against the tension of said spring; and
the combination of said selected end of said clamping member and said folded spring is placed within said securing member wherein said securing member and said helical spring are in co-axial alignment.

2. The toggle bolt fastener assembly of claim 1 wherein:
said securing member has a generally disc-shaped front portion and a tubular protruding rear portion, said front portion and said rear portion having the same inside diameter with said rear portion having a smaller outside diameter than said front portion;
said rear portion having an outside diameter suitable for insertion into said hole whereas said disc-shaped front portion has a diameter large enough to cover said hole and preclude passage therethrough of said securing member; and
wherein said clamping member and said folded spring are inserted within said rear portion of said securing member.

3. The toggle bolt fastener assembly of claim 2 wherein:
said clamping member includes a lengthwise trough for receiving said spring prior to placement of said first end within said securing member; and
said spring is attached to said trough.

4. The toggle bolt fastener assembly of claim 3 wherein said clamping member includes a threaded nut located opposite to said trough and accessible through a hole in said trough, with said nut and said spring having a common axis.

5. The toggle bolt fastener assembly of claim 4 including a bolt for insertion through said securing member and said spring to press against the junction of said folded spring and said clamping member to release said clamping member from said securing member allowing said clamping member to spring back perpendicular to said spring.

6. A toggle bolt fastener for mounting articles onto a hollow mounting member, comprising:
a hollow securing member configured for removable fitting within a hole in a mounting member, said securing member having a front portion and a protruding rear portion, said front portion and said rear portion having the same inside dimensions with said rear portion having smaller outside dimensions than said front portion;
said rear portion having outside dimensions suitable for insertion into said hole whereas said front portion has outside dimensions large enough to cover said hole and preclude passage therethrough of said securing member;
a longitudinal extending toggle clamping member having a lengthwise trough and a threaded nut located opposite said trough proximate the center of said clamping member, said nut accessible through a hole in said trough;
longitudinal extending resilient means having a first end attached to said clamping member approximate the center thereof and a second end attached to said securing member, said resilient means configured and attached for urging proximity of said clamping member and said securing member; and
a threaded bolt having dimensions suitable for insertion through the inside dimension of said securing member and threads mateable with said threaded nut.

7. The toggle bolt fastener of claim 6 wherein:
said clamping member is bent back 90 degrees in-line with said securing member and said resilient member placed within said trough in said clamping member;
said clamping member and said resilient member inserted into said back portion of said hollow securing member;
the combination of said clamping member and said resilient member inserted into said back portion of said hollow securing member;
the combination of said clamping member, said resilient member and said securing member inserted through a hole in said mounting surface until stopped by the larger diameter front portion of said securing member after which said threaded bolt is pushed through said securing member from the front thereof to force said clamping member to emerge from said mounting surface hole and spring back to an upright position relative to said bolt and then spring back against the interior of said mounting surface, said resilient member urged to maintain its original orientation thus resisting rotation of said clamping member; and
said bolt is screwed into said threaded nut on the backside of said clamping member to firmly place said clamping member against the inside of said mounting surface.

8. The toggle bolt fastener of claim 7 wherein:
said bolt is removed from the installed fastener, attached to an object to be secured to said mounting surface, inserted through said fastener, and threaded into said nut of said clamping member thereby tightening said clamping member against the inside of said mounting surface and securely mounting said object.

9. The toggle bolt fastener of claim 7 wherein said securing member has a disc-shaped front portion and a tubular rear portion, said longitudinal extending resilient means is a helical spring, and said spring includes an associated flexible sleeve covering at the junction of said spring and said clamping member.

10. A toggle bolt fastener for mounting articles onto a wall member, comprising:
a hollow securing member for fitting within a hole in a wall member;
a toggle clamping member;
a helical spring having a first end attached to said toggle clamping member and a second end attached to said securing member;
said clamping member folded along said spring;
a portion of said clamping member and said folded spring placed within the hollow of said securing member, said securing member and said helical spring generally in co-axial alignment; and
a bolt inserted through said securing member and said spring to force said clamping member from said securing member thereby allowing said clamping member to regain its relation to said spring and open behind said wall member.
